(19) United States
(12) Patent Application Publication
(10) Pub. No.: US 2006/0260362 A1
(43) Pub. Date: Nov. 23, 2006

(54) Method for producing glass and an apparatus relating to the same

(76) Inventors: James M. Uhlik, New Lenox (DE); Andreas Langsdorf, Ingelheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/431,101

(22) Filed: May 10, 2006

Related U.S. Application Data
(60) Provisional application No. 60/679,651, filed on May 11, 2005.

(51) Int. Cl. C03B 18/00

(52) U.S. Cl. 65/182.3

(57) ABSTRACT

A float tank comprise a lower chamber for containing a molten metal adapted to support a glass ribbon for producing a glass by a float forming process, wherein the float tank contains a first atmosphere generally above at least a portion of the glass ribbon and generally not above the molten metal, and a second atmosphere generally above the molten metal and not above the glass ribbon, wherein the first atmosphere differs in composition from the second atmosphere.

This application claims the benefit of the filing date of U.S. Provisional Application Ser. No. 60/679,651 filed May 11, 2005.

The present invention generally relates to a glass, a process for manufacturing a glass, and an apparatus pertaining to the same.

Generally, a float forming method for making thin flat glass utilizes a tank or bath of molten metal, typically tin, to support a glass ribbon formed thereon. The glass ribbon is drawn from the float tank to form glass sheets. To prevent oxidation of the molten tin, a high-purity gas mixture, such as a mixture of nitrogen and hydrogen, can be introduced through the roof of the float tank. Although nitrogen is inert, hydrogen in the mixture may react with any infiltrating oxygen and reduce any oxides that may occur in the molten metal bath thereby preventing or reversing oxidation.

However, some glass components, such as refining agents, are susceptible to reduction due to the presence of reducing agents such as hydrogen. Thus, reduction of such components may result in the formation of impurities within the glass, particularly at or near its surface, creating defects in the final glass product. As a result, float-forming processes which employ a reducing atmosphere are not desirable with some glass products due to the undesirable reduction of certain components in the glass. Attempts to control the contents of the atmospheres above the glass ribbon and molten metal suffer disadvantages due to insufficient separation of the different atmospheres.

Consequently, it would be desirable to provide a glass making process and/or apparatus that overcome these deficiencies.

### SUMMARY OF THE INVENTION

The present invention can provide a float tank that includes a chamber for containing a molten metal adapted to support a glass ribbon for producing a glass by a float forming process. The float tank can further contain a first atmosphere, preferably an inert or oxidative atmosphere, generally above at least a portion of the glass ribbon and generally not above the molten metal, and a second atmosphere, preferably a reducing atmosphere, generally above the molten metal and not above the glass ribbon. Generally, the first atmosphere differs in composition from the second atmosphere. Desirably, at least one partition is provided generally, desirably substantially, perpendicular to the length of the glass ribbon at an outlet, where the glass ribbon is removed from the float tank, to help contain the first atmosphere. Preferably, two or more partitions are provided. Additionally, the invention can also provide a glass manufacturing plant which comprises a furnace, a float tank as described above and below, and a lehr or annealing oven.

Thus, in accordance with the invention, there is provided an apparatus comprising a float tank having a lower chamber and an upper chamber wherein the lower chamber is adapted to contain a bath of molten metal, preferably tin, to receive molten glass which forms a ribbon of glass on the surface of the molten metal, and to discharge the ribbon of glass. The upper chamber is adapted to contain a first atmosphere and a second atmosphere which is separated from the first atmosphere, where the first atmosphere is predominately above the glass ribbon and the second atmosphere is predominately above the molten metal. Desirably, at least one partition is provided generally, desirably substantially, perpendicular to the length of the glass ribbon at an outlet, where the glass ribbon is removed from the float tank, to help contain the first atmosphere. Preferably, two or more partitions are provided.

According to another aspect, the invention provides an apparatus comprising a float tank having an inlet for introducing molten glass, an outlet for discharging a glass ribbon, a lower chamber adapted to contain a bath of molten metal such as molten tin, and an upper chamber adapted to provide a first atmosphere above a glass ribbon supported by the bath of molten metal, and a second atmosphere above one or more portions of the bath of molten metal. For example, the first and second portions of the baffle or barrier, optionally adjustable, can divide the upper chamber into three sections, a middle section over at least a portion of the glass ribbon, and two side sections over edges of the molten metal bath. Desirably, at least one partition is provided generally, desirably substantially, perpendicular to the length of the glass ribbon at an outlet, where the glass ribbon is removed from the float tank, to help contain the first atmosphere. Preferably, two or more partitions are provided.

Moreover, the float tank may further include a means for segregating the first and second atmospheres such as a baffle or barrier. The baffle or barrier, optionally adjustable, may be made form any suitable material such as metal or graphite. Desirably, the barrier or baffle may include at least first and second portions generally extending longitudinally in the direction of the longitudinal axis of the glass ribbon thereby defining a region proximate to an outline of the glass ribbon. Desirably, at least one partition is provided generally, desirably substantially, perpendicular to the baffle or barrier at or near an outlet, where the glass ribbon is removed from the float tank.

According to still another aspect, the invention provides an apparatus comprising a float tank having an inlet for introducing molten glass, an outlet for discharging a glass ribbon, a lower chamber, an upper chamber and a baffle or barrier having at least first and second portions for dividing the upper chamber into three sections. So, the upper chamber is adapted to contain a first atmosphere and a second atmosphere where the first atmosphere is predominately above the glass ribbon and the second atmosphere is predominately above the molten metal. Desirably, at least one partition is provided generally, desirably substantially, perpendicular to the length of the glass ribbon at or near the outlet, where the glass ribbon is removed from the float tank, to help contain the first atmosphere. Preferably, two or more partitions are provided.

Alternatively, the barrier can include first and second portions generally defining a region proximate to an outline of the glass ribbon, and a third portion generally perpendicular to the glass ribbon, upstream of first and second top rolls, and coupled to the first and second portions. Generally, the first and second top rolls provide a means for advancing the glass ribbon.

The barrier or baffle can be coupled to a roof and extend downward partitioning an upper chamber. Preferably, the barrier or baffle extends downward to a point near the surfaces of the molten metal and the glass ribbon, preferably about 10 mm-about 100 mm above the glass ribbon. Desirably, at least one partition extends downward to a point near the surfaces of the molten metal and the glass ribbon, preferably about 10 mm-about 100 mm above the glass ribbon.

Alternatively, the means for segregating or the barrier can be a gas jet.

The barrier or baffle generally segregates the first atmosphere, predominately over the glass ribbon, from the second atmosphere, predominately over the molten metal. What is more, the float tank may also further include a gas distribution system for introducing the first and second atmospheres.

Alternatively, the present invention can provide a float tank for producing glass by a float forming process. The float tank can include a lower chamber, an upper chamber, a roof and a barrier. The lower chamber can be adapted to receive a molten metal, and the barrier may be coupled to the roof, extend downward to a point proximate to the lower chamber to partition the upper chamber, and segregate a first atmosphere, generally above at least a portion of a glass ribbon, and a second atmosphere, generally above at least a portion of the molten metal. Desirably, at least one partition is provided generally, desirably substantially, perpendicular to the length of the glass ribbon near an outlet to help contain the first atmosphere.

Moreover, the present invention can provide a process of creating gaseous atmospheres in a float tank for a glass float forming process. The process can include providing a barrier generally defining a region proximate to an outline of a molten glass ribbon, and providing a predominantly reducing gas atmosphere over a molten metal and a predominantly inert atmosphere over the glass ribbon. Desirably, at least one partition is provided generally, desirably substantially, perpendicular to the length of the glass ribbon at or near an outlet, where the glass ribbon is removed from the float tank, to help contain the first atmosphere.

What is more, the first atmosphere can include nitrogen, oxygen, carbon dioxide, air or a mixture thereof, and the second atmosphere can include a mixture of nitrogen and hydrogen, or carbon monoxide. Preferably, the first atmosphere includes nitrogen (for example, at least about 96% by volume), and the second atmosphere generally includes about 88-about 96% by volume nitrogen and about 12-about 4% by volume hydrogen, preferably about 90-about 96% by volume nitrogen and about 10-about 4% by volume hydrogen, and optimally about 94% or about 95% by volume nitrogen and about 6% or about 5% by volume hydrogen. Generally, the first atmosphere contains significantly less hydrogen (e.g. 30% by volume less) than the second atmosphere or even no hydrogen. For example, the first atmosphere can contain about 4 vol % hydrogen and the second atmosphere can contain about 8 vol % hydrogen.

Also, the present invention may provide a process for providing within a float tank at least two atmospheres with differing compositions over a lower chamber containing a molten metal with a glass ribbon thereon. The process can include providing a float tank with an inlet for receiving molten glass that can form a glass ribbon and an outlet for discharging the glass ribbon. A barrier can segregate an upper chamber of the float tank to contain a first atmosphere, predominately above the glass ribbon, from a second atmosphere, predominately above the molten metal, where gases are introduced to differ the compositions of the first and second atmospheres. Desirably, at least one partition is provided generally, desirably substantially, perpendicular to the length of the glass ribbon at or near the outlet, where the glass ribbon is removed from the float tank, to help contain the first atmosphere.

Generally, the glass is made from SiO₂, B₂O₃, Al₂O₃, Li₂O, Na₂O, K₂O, BaO, ZnO, TiO₂, La₂O₃, Sb₂O₃, Sb₂O₅, SnO₂, or As₂O₃, or combination or combinations thereof.

Thus, the present invention can provide a glass making apparatus, system and/or process that provides a first atmosphere that reduces imperfections in the glass, and a second atmosphere above the molten metal to reduce oxidation thereof. What is more, the present invention can provide a partition generally, desirably substantially, perpendicular to the length of the glass ribbon at or near an outlet, where the glass ribbon is removed from the float tank, and/or an adjustable barrier or baffle to help contain the first atmosphere and prevent mixing of the first atmosphere with the second atmosphere and exposing the glass ribbon to the second atmosphere. The present invention not only improves the process of making glass by, e.g., permitting the processing of more glass varieties by the float forming method, but also the final glass product as well.

### BRIEF DESCRIPTION OF THE DRAWINGS

FIG. 1 depicts a schematic diagram of an exemplary glass manufacturing plant of the present invention.

FIG. 2 depicts an elevational, side and cut-away view of an exemplary float tank of the present invention.

FIG. 3 depicts an elevational and back view of an exemplary float tank of the present invention.

FIG. 4 depicts a plan, top, and cross-sectional view along 4-4 in FIG. 2 of an exemplary float tank of the present invention.

FIG. 5 depicts an elevational, front, and cross-sectional view along 5-5 in FIG. 2 of an exemplary float tank of the present invention.

FIG. 6 depicts a plan, top, and cross-sectional view along 6-6 in FIG. 2 of another exemplary float tank of the present invention.

As used herein, the term “predominately” means more than 50%, preferably at least 70%, especially at least 80%, and in particular, at least 90%.

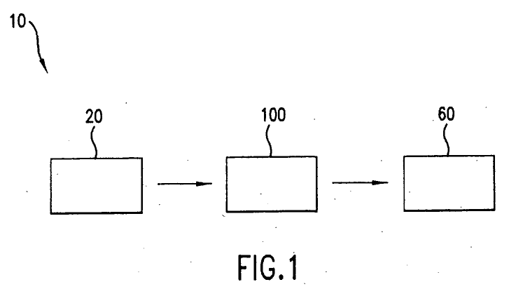

Referring to FIG. 1, a glass making plant 10 generally includes at least one furnace 20, float tank or bath 100, and lehr 60. Generally, the float tank 100 is positioned between a furnace 20 and a lehr 60 where molten glass is fed from the furnace 20 into an inlet 138 of the float tank 100 and subsequently, sheets of glass are pulled from the float tank 100 from an outlet 142 into the lehr 60.

The furnace 20 and the lehr 60 may be those known in the art, such as disclosed in U.S. Pat. No. RE 31,466; U.S. Pat. Nos. 4,303,437; and 3,980,170 (relevant to lehrs), and in U.S. Pat. No. 4,769,059 (relevant to furnaces), although other lehrs or furnaces can be used.

Similarly, the float bath 100, can be a float bath known to those of skill in the art, such as those disclosed in U.S. Pat. Nos. 3,930,829; 3,934,994; 3,951,633; 3,958,969; 3,961,930 3,970,442; 3,996,034; 4,001,476; 4,013,438; 4,046,549; RE 29,464; U.S. Pat. Nos. 4,074,994; 4,081,260; 4,091,156; 4,093,439; 4,115,091; 4,116,660; 4,131,446; 4,141,713; 4,148,622; 4,157,908; 4,162,907; 4,188,200; 4,197,107; 4,203,750; 4,217,125; 4,233,047; 4,279,634; 4,311,508; 4,312,656; 4,319,908; 4,322,235; 4,322,236; 4,340,412; 4,340,411; 4,340,410; 4,361,431; 4,395,272; 4,439,222; 4,548,636; 4,741,749; 4,749,400; 4,784,680; 4,828,900; 4,940,479; 4,995,893; 5,156,667; 5,278,108; 5,364,435; 5,747,398; 5,939,016; 6,065,309; 6,087,284; 6,089,043; and 6,094,942 or other float baths, which can be modified with, e.g., a barrier 200 or a means for segregating 200, as discussed hereinafter.

The float tank 100 may be a movable float tank including a transport assembly 300 and an adapter 400 as disclosed in U.S. patent application Ser. No. 10/607,527, filed 27 Jun. 2003, which is hereby incorporated by reference, as modified by the present invention. However, it should be understood that much larger float tanks can be used, such as those having throughputs of 100-800 tons per day.

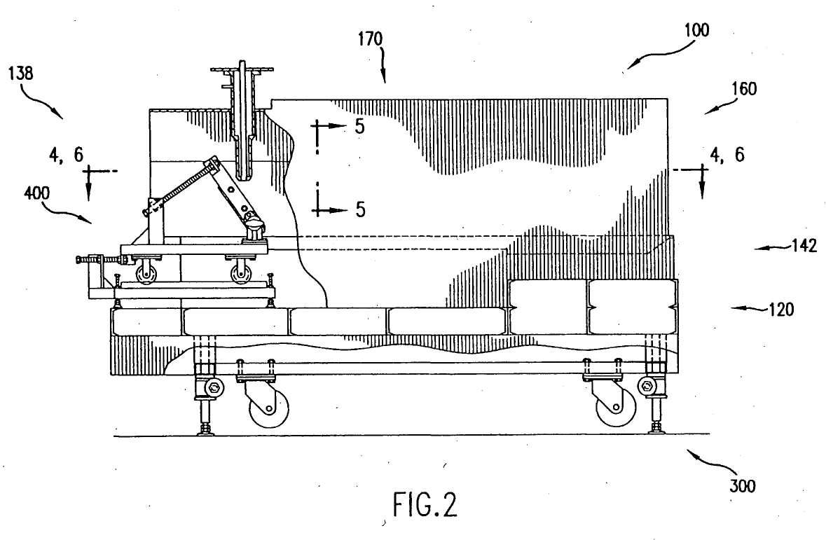

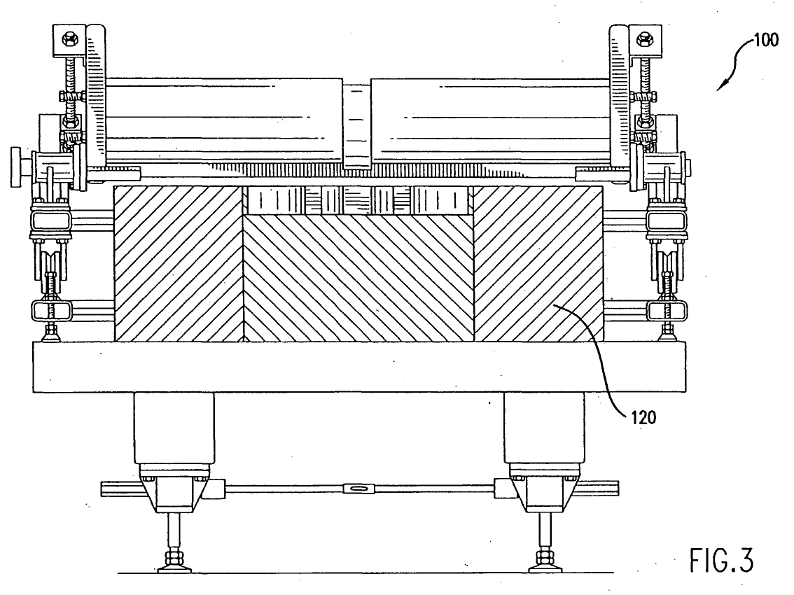

Referring to FIGS. 2-6, an exemplary float tank 100 is depicted. The float tank 100 of the present invention can include a lower chamber 120, an upper chamber 160, a roof 170, and a distribution system 180. The lower chamber 120 generally contains a molten metal 146, such as tin, for supporting a molten glass ribbon 152 poured thereon from a furnace 20. The lower chamber 120 can further include first and second top rolls 124 and 126 and first and second fences 134 and 136.

The float tank 100 can further include the barrier or baffle 200 or the means for segregating the first and second atmospheres 200. The barrier 200 at least partially separates a first atmosphere overlying at least a portion 153 of the ribbon 152 and a second atmosphere overlying at least a portion of the molten metal 146, and optionally edges 158 of the ribbon 152. The barrier 200 maybe coupled to the roof 170 using any suitable means such as welds or mechanical fasteners, such as bolts, and extends downward from the roof 170 to just above the glass ribbon 152, generally from about 10 mm-about 100 mm above the glass ribbon 152.

The barrier 200 may also be coupled using any suitable means to the walls of the upper chamber 160.

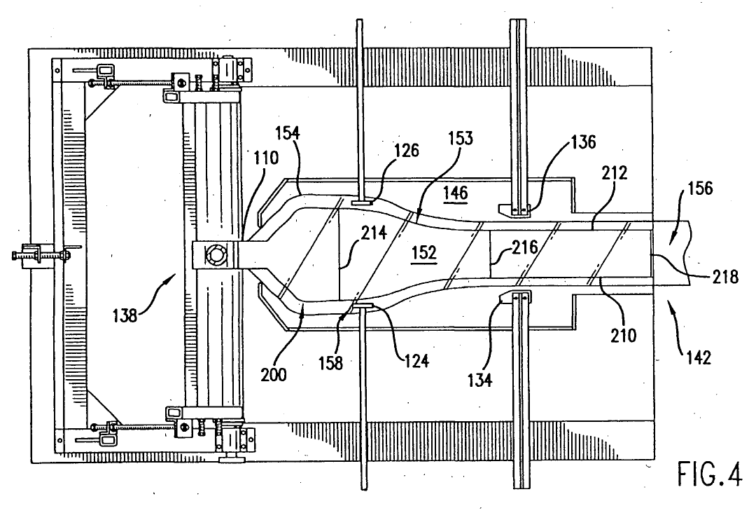

In one exemplary embodiment as depicted in FIG. 4, the barrier 200 is generally overlying the portion 153 proximate to an outline 154 of the glass ribbon 152. The barrier 200 can be made from a material adapted to withstand the temperatures inside the float tank 100. Suitable materials for construction of the barrier 200 can include ceramic, e.g. Al₂O₃- or SiO₂-based ceramics, ceramic or metallic fabrics, high-temperature alloys, such as a nickel-chromium-molybdenum alloy, sold under the trade designation NICROFER by Krupp UM GmbH, steel, graphite (if oxygen is strictly limited in the atmosphere), or any other materials that can withstand temperatures, e.g., 100-1200° C. and atmospheres of the float tank 100. Alternatively, a cooling system can be incorporated into the barrier 200 to prevent it from melting. The barrier 200 can be stationary or adjustable. It is further understood that the barrier 200 does not necessarily have to be a metal, or even a solid barrier, but instead maybe comprised of a gas jet or curtain.

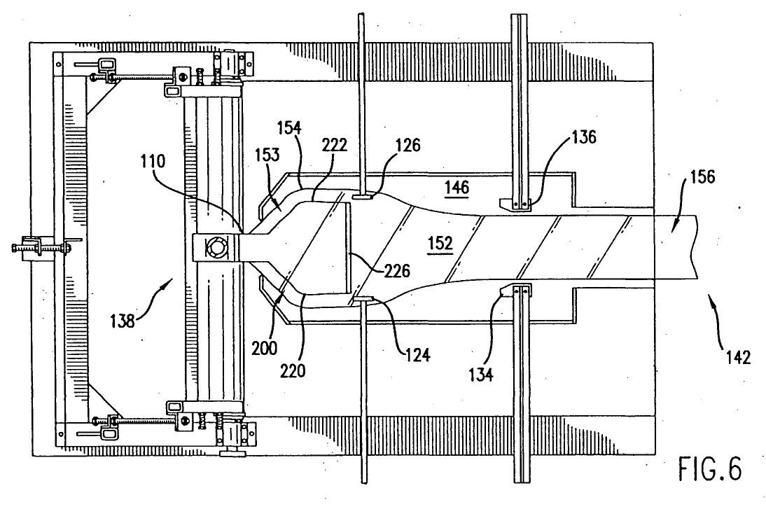

Generally, the barrier 200 is positioned to overlie at least a portion 153 proximate to the outline 154 of the glass ribbon 152 at steady-state conditions and can include portions 210 and 212 that overlie respective edges 158 of the glass ribbon 152. Generally, the barrier 200 extends from a lip 110 where molten glass is poured from the furnace 20 onto the molten metal 146 to the end of the tank 100 where the glass ribbon 152 exits the tank 100. Referring to FIG. 6, the barrier 200 alternatively can include portions 220, 222, and 226 coupled to the upper chamber 160 using any suitable means such as welds or mechanical fasteners that segregate a first atmosphere as described hereinafter overlying the glass ribbon 152 below the inlet of the molten glass and upstream of the first and second top rolls 124 and 126, generally in the hot region of the float bath 100.

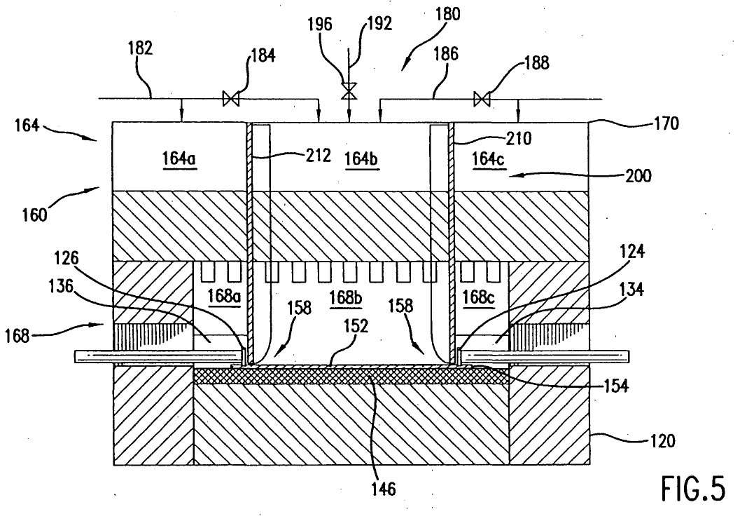

Optionally, partitions 214, 216 and 218 are provided (depicted in FIG. 4 but not FIG. 5) to help contain the first atmosphere above the glass ribbon 152 and prevent mixing of the first and second atmospheres. Desirably, the partition 214 is positioned upstream of top rolls 124 and 126, the partition 216 is positioned upstream of fences 134 and 136, and the partition 218 is positioned near the outlet 142. The partitions are coupled to the upper chamber 160 or roof 170 using any suitable means, such as welds or mechanical fasteners, and extend to 10 mm-100 mm above the glass ribbon 152. The partitions 214, 216 and 218 are generally (about 45°-about 135°), desirably substantially (about 80°-about 100°) perpendicular to the length (dimension spanned by the ribbon 152 from the inlet 138 to the outlet 142) of the glass ribbon 152. In one preferred embodiment, the float tank 100 includes just one partition 218 near the outlet 142.

In one exemplary adjustable embodiment, the barrier 200 can include a series of segmented sections. These segmented sections can be coupled to tracks in the roof 170. Sensors can be provided within the float tank 100 (e.g., attached to the roof 170) to detect the movement of the glass ribbon 152. As an example, if the ribbon 152 should move significantly during steady-state conditions, the sensors can provide signals to adjust the position of one or more segments of the barrier 200 so that the barrier will generally overlie the portion 153 proximate to the outline 154 of the glass ribbon 152.

Examples of gas distribution systems for introducing gas into the float tank 100 are disclosed in, for example, U.S. Pat. Nos. 3,462,253; 3,970,442; 5,364,435 and 6,094,942.

Referring to FIG. 5, the gas distribution system 180 can include a first conduit 182, a second conduit 186, and a third conduit 192, as well as a first valve 184 and a second valve 188. Optionally, a third valve 196 can be included. A second atmosphere, generally a reducing gas mixture such as a mixture of nitrogen and hydrogen, can be fed into the conduit 182. With gas flowing into the conduit 182 and the valve 184 closed, the gas enters a service space 164 and travels down into a headspace 168 above the molten metal 146 and the edges 158 of the glass ribbon 152. In addition, with the valve 188 closed, another second atmosphere of a reducing gas mixture such as a mixture of nitrogen and hydrogen can be introduced through the conduit 186 to enter the service space 164 and subsequently into the headspace 168. The gases in conduits 182 and 186 are preferably the same, but may be different. Until the production of glass is at steady-state, the gases throughout the head space 168 can be a reducing atmosphere, particularly at start-up to prevent oxidation of the tin. Moreover, a first atmosphere of an inert gas such as nitrogen can be introduced through the conduit 192 into the service space 164 and subsequently to the headspace 168, where the barrier 200 separates the first and second atmospheres.

Particularly, the service space 164 and head space 168 can be divided into, respectively, service spaces 164a-c and head spaces 168a-c. Generally, the service spaces 164a and 164c and head spaces 168a and 168c are above the molten metal 146 and the service space 164b and head space 168b are above the glass ribbon 152.

The barrier 200 segregates these gases so that the first atmosphere is generally above the glass ribbon 152 and the second atmosphere is generally above the molten metal 146. Alternatively, valves 184 and 188, while generally closed, can be opened to expose the glass ribbon 152 to the same reducing atmosphere, e.g., nitrogen and hydrogen, as the molten metal 146 if, e.g., the glass ribbon 152 does not contain refining agents susceptible to reduction. Although the edges 158 of the ribbon 152 can extend outside the barrier 200, often these edges 158 are trimmed during production and thus are not included in the final glass product. So contamination of the glass ribbon 152 at the edges 158 will generally not affect the final glass product. It should be understood that additional conduits can be provided should one or more partitions 214, 216 and/or 218 be present further segregating the service space 164 and hard space 168

The first atmosphere can be an inert or oxidative gas such as nitrogen, oxygen, carbon dioxide, air or a mixture thereof. However, the first atmosphere can include a low content of at least one reducing gas, such as hydrogen, albeit at a reduced content (e.g., <5% by volume) as compared to the hydrogen in the atmosphere above the molten metal 146. The second atmosphere generally above the molten metal can be a reducing atmosphere of a mixture of nitrogen and hydrogen, optionally including carbon monoxide. Alternatively, the reducing atmosphere generally above the molten metal can be carbon monoxide. Preferably, the first atmosphere above the glass ribbon 152 is an inert atmosphere such as nitrogen and the second or reducing atmosphere is a mixture of nitrogen and hydrogen. Generally, the reducing atmosphere includes about 88-about 96% by volume nitrogen and about 12-about 4% by volume hydrogen, more preferably about 90-about 96% by volume nitrogen and about 10-about 4% by volume hydrogen, and optimally about 94 or about 95% by volume nitrogen and about 6 or about 5% by volume hydrogen. In one exemplary embodiment, the gas provided by the conduit 192 is at a higher flow than the gases provided by the conduits 182 and 186 to create an overpressure, so gas flows from above the glass ribbon 152 to above the molten metal 146 to prevent defects from evaporation products. Not only does the inert and reducing atmosphere tend to, respectively, protect the glass ribbon 152 and keep air out of the bath to prevent oxidation, these atmospheres can also provide cooling to electrical connections and the heating elements typically positioned in the service and head spaces 164 and 168.

Generally, the produced glass has a thickness of about 1 mm-about 12 mm, preferably about 2 mm-about 8 mm and optimally about 6 mm, although other thicknesses of glass can be made dependent on the desired use, e.g., about 0.3 mm-about 1.5 mm, optimally about 0.7 mm. Generally, the molten glass enters the float bath 100 at a temperature of about 1000° C.-about 1200° C. and a glass 156 exits at a temperature of about 500° C.-about 700° C.

A process of the present invention can be utilized with all sorts of glasses known to be suitable for float bath processes. Desirably, the glass is a soda lime, borosilicate, optical, or other float glass, including a glass made from and/or including SiO₂, BaNO₃, Na₂CO₃, K₂CO₃, K₂NO₃, B₂O₃, Al₂O₃, Li₂O, Na₂O, K₂O, NaCl, KHF₂, NH₄Cl, CaO, SrO, PbO, Sb₂O₃, Sb₂O₅, Fe₂O₃, Fe₃O₄, NiO, Ni₂O₃, CoO, CO₂O₃, Cr₂O₃, Mn₂O₃, V₂O₅, Nd₂O₃, CeO₂, Pr₂O₃, Er₂O₃, BaO, ZnO, TiO₂, La₂O₃, As₂O₃, SnO₂, CuO, F₂, other oxides, or a combination or combinations thereof. Particularly, the process and apparatus of the present invention is suited for making glasses susceptible to reduction of oxides, such as those-including refining agents (e.g., glasses including oxides of As, Sb, and/or Sn) due to exposure to a reducing atmosphere. Such glasses can include display glasses, if the glasses have a high SnO₂ content (e.g. 0.1%), such as TFT glasses, which are generally used in displays. Other glasses are green glasses used in ceramics. Such glasses, if reduced, can have purity problems as the result of a ceramization step during processing.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

### EXAMPLE

The following example utilizes a nitrogen atmosphere to duplicate the time/temperature exposure of glasses as in a microfloat tin bath (see, supra, U.S. application Ser. No. 10/607,527, filed 27 Jun. 2003) in an inert atmosphere of nitrogen. A reducing atmosphere of e.g., 95% nitrogen and 5% hydrogen, is omitted.

The testing procedures can include slowly heating a refractory block to a temperature of 2000° F. (1100° C.). Next, a glass is melted at 2000° F. (1100° C.). Afterwards, 1-2 pounds (0.45-0.91 kilograms) of tin is incrementally added to minimize shock until 5 pounds (2.27 kilograms) of tin is in the block, optionally afterwards de-drossing. Once 2000° F. (1100° C.) is reached, a nitrogen purge can begin. That being done, installing carbon edge liners prevents glass sticking to the refractory block edges. After verifying that the temperature of 2000° F. (1100° C.) has been reached, the glass is poured slowly on the tin surface.

Afterwards, the furnace is cooled as quickly as possible to ideally bring the glass temperature down to 1100° F. (600° C.) in about 3-4 minutes. Optionally, nitrogen can be used to cool the block, tin and glass, or radiant heat absorbing water coolers are used to cool the glass. Next, the glass is removed from the tin and annealed in an oven, and subsequently allowed to cool to room temperature. Subsequently, the glass is analyzed for surface defects and SEM to determine the depth of tin penetration.

Five glass samples can be tested. Four of these glasses are sold under the trade designations NBK-7, S-3, S-8807, and S-8808 by Schott North America of Elmsford, N.Y., whose chemical compositions and physical properties are depicted in Table 1. The fifth glass is a normal soda lime float glass.

TABLE 1

| | PRODUCT NAME | | | |
|---|---|---|---|---|
| | | | | S-8808 |
| | NBK-7 | S8807 | S-3 | (IN |
| | (IN WT %) | (IN WT %) | (IN WT %) | WT %) |
| (COMPO- | | | | |
| SITION) | | | | |
| Aluminum Oxide | n/a | n/a | 1-10 | 1-10 |
| Antimony | <1 | n/a | <1 | n/a |
| Trioxide | | | | |
| Arsenic Trioxide | n/a | n/a | <1 | n/a |
| Barium Oxide | >0-10 | n/a | n/a | 1-10 |
| Boron Oxide | 10-20 | 1-10 | 1-10 | 1-10 |
| Calcium Oxide | <1 | n/a | n/a | <1 |
| Cerium Oxide | n/a | <1 | n/a | 1-10 |
| Chromium Oxide | n/a | n/a | n/a | <1 |
| Copper Oxide | n/a | <1 | n/a | <1 |
| Erbium Oxide | n/a | n/a | n/a | <1 |
| Lanthanum Oxide | n/a | n/a | n/a | 1-10 |
| Manganese Oxide | n/a | n/a | n/a | <1 |
| Neodymium | n/a | 10-20 | n/a | 1-10 |
| Oxide | | | | |
| Potassium Oxide | 5-15 | n/a | 1-10 | 10-20 |
| Silica | 60-70 | >50 | >51 | n/a |
| Sodium Oxide | 1-15 | 10-20 | 1-10 | n/a |
| Titanium Oxide | <1 | n/a | <1 | n/a |
| Zinc Oxide | <1 | 1-10 | 11-20 | n/a |
| (PROPERTIES) | | | | |
| Melting Point | 532° C. | 712° | 735° C. | n/a |
| Density | 2.39 g/cm³ | 2.91 g/cm³ | 2.60 g/cm³ | n/a |

The amount of tin penetration as determined by SEM is depicted below:

TABLE 2

| Glass Samples | | Tin Penetration |
|---|---|---|
| 1. | Normal Soda Lime Float Glass | 7 μm |
| | Sample A | |
| | Sample B | up to 15 μm |
| 2. | NBK-7 | 5 μm |
| 3. | S3 with Nd | Barely Detectable |
| 4. | S 8807 | 4 μm |
| 5. | S 8808 | 10 μm with 300 μm fingers |

In sample numbers 1-3 and 5, the depth of tin penetration can vary over different areas of the sample. These variations may be due to the irregular surfaces of the samples as well as the testing procedure. The values reported are approximations of the deepest penetration of tin detected based on the number of scans. With respect to sample 5, the penetration to 300 μm appears to be due to a defect in the sample because most of the surface has a penetration of only 10 μm.

The entire disclosures of all applications, patents and publications, cited herein and of corresponding U.S. Provisional Application Ser. No. 60/679,651, filed May 11, 2005 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A float tank comprising a lower chamber for containing a molten metal adapted to support a glass ribbon for producing a glass by a float forming process, wherein the float tank contains a first atmosphere generally above at least a portion of the glass ribbon and generally not above the molten metal, and a second atmosphere generally above the molten metal and not above the glass ribbon, wherein the first atmosphere differs in composition from the second atmosphere.

2. A float tank according to claim 1, wherein the first atmosphere is an inert or oxidative atmosphere and the second atmosphere is a reducing atmosphere.

3. A float tank according to claim 1, wherein the first atmosphere comprises nitrogen, oxygen, carbon dioxide, air or a mixture thereof, and the second atmosphere comprises a mixture of nitrogen and hydrogen, or carbon monoxide.

4. A float tank according to claim 3, wherein the first atmosphere comprises nitrogen.

5. A float tank according to claim 1, wherein the second atmosphere comprises about 88-about 96% by volume nitrogen and about 12-about 4% by volume hydrogen.

6. A float tank according to claim 1, wherein the second atmosphere comprises about 90-about 96% by volume nitrogen and about 10-about 4% by volume hydrogen.

7. A float tank according to claim 1, wherein the second atmosphere comprises 94% or 95% by volume nitrogen and about 6% or about 5% by volume hydrogen.

8. A float tank according to claim 1, wherein the float tank further comprises a lower chamber adapted to contain the molten metal, and a barrier coupled to a roof and extending downward partitioning an upper chamber, wherein the barrier segregates the first atmosphere predominantly over the glass ribbon and the second atmosphere predominantly over the molten metal.

9. A float tank according to claim 8, wherein the barrier comprises a metal.

10. A float tank according to claim 8, wherein the barrier is a gas jet.

11. A float tank according to claim 8, wherein the barrier extends downward to near the surface of the molten metal and glass ribbon.

12. A float tank according to claim 1, wherein the molten metal comprises tin.

13. A float tank according to claim 1, wherein the glass is made from SiO₂, B₂O₃, Al₂O₃, Li₂O, Na₂O, K₂O, BaO, ZnO, TiO₂, La₂O₃, Sb₂O₃, Sb₂O₅, SnO₂, or As₂O₃, or a combination thereof.

14. A float tank according to claim 1, further comprising a gas distribution system.

15. A float tank for producing glass by a float forming process, comprising a lower chamber, an upper chamber, a roof and a barrier; wherein the lower chamber is adapted to receive a molten metal; the barrier is coupled to the roof, extends downward proximate to the lower chamber to partition the upper chamber, and segregates a first atmosphere generally above at least a portion of a glass ribbon and a second atmosphere generally above at least a portion of the molten metal.

16. A method of creating gaseous atmospheres in a float tank for a glass float forming process, comprising:
providing a barrier generally overlying at least a portion proximate to an outline of a molten glass ribbon; and
providing a predominantly reducing gas atmosphere over a molten metal and a predominantly inert atmosphere over the glass ribbon.

17. A float tank according to claim 8, wherein the barrier comprises first and second portions generally overlying at least a portion proximate to an outline of the glass ribbon.

18. A float tank according to claim 8, wherein the barrier comprises first and second portions generally overlying at least a portion proximate to an outline of the glass ribbon, and a third portion generally perpendicular to the glass ribbon upstream of first and second top rolls, and coupled to the first and second portions.

19. A float tank according to claim 1, further comprising a means for segregating the first and second atmospheres.

20. A glass manufacturing plant, comprising at least one furnace, at least one float tank according to claim 1, and at least one lehr.
